(19) United States
(12) Patent Application Publication
(10) Pub. No.: US 2019/0359273 A1
(43) Pub. Date: Nov. 28, 2019

(54) CABLE-CONTROLLED ADJUSTING APPARATUS OF BICYCLE HANDLEBAR END

(71) Applicant: TIEN HSIN INDUSTRIES CO., LTD., Taichung City (TW)

(72) Inventor: JASON MILES, Taichung City (TW)

(21) Appl. No.: 15/987,236

(22) Filed: May 23, 2018

(51) Int. Cl. B62J 1/08; B62K 23/02; F16C 1/16; F16H 25/18

(52) U.S. Cl. CPC B62J 1/08; B62K 23/02; B62K 21/12; F16H 25/186; B62J 2001/085; F16C 1/16

(57) ABSTRACT

The present disclosure provides a cable-controlled adjusting apparatus. The cable-controlled adjusting apparatus includes an adjusting element rotatably joined with the fastening element of a handlebar of a bicycle and a fixing element. A stopping wall is disposed on the adjusting element. A plurality of first grooves is disposed on the stopping wall. The fixing element includes a rod body passing through the adjusting element and an elastic element and includes a head portion pressing against the stopping wall. A plurality of second grooves is disposed on the head portion toward the adjusting element. A ball is sandwiched between the first and second grooves. The elastic element is located between a stopping member and the stopping wall. A cable passes through the fixing element. One end of the cable is fixed to the head portion and the other end passes through the fastening element and is connected to a controller.

### BACKGROUND

### Technical Field

The present disclosure relates to a cable-controlled adjusting apparatus of a bicycle, and in particular, to a cable-controlled adjusting apparatus disposed in a bicycle handlebar end.

### Related Art

Generally, a road bike requires a cyclist to tilt more forwardly than a common bicycle does. A standard and optimal height of a seat post is a height that while a pedal is pushed to a lowest point by a heel of a feet, a knee is slightly bent, at which is the position that the feet can apply force easier. Referring to FIG. 1, when a cyclist riding downhill, a body is tilting forward. In this case, a larger distance between a seat post and the ground indicates a larger angle of inclination between the body and the ground, leads to a center of gravity P of the body lies over the front part of a bicycle, causing the body to dive forward and the bicycle is easy to overturn, which is quite dangerous. Therefore, a cyclist usually pre-lowers a seat post, to adjust the center of gravity and maintain a relatively low cycling posture. Referring to FIG. 2, when riding uphill, the center of gravity P of a body moves backward as a touching angle between a bicycle and the ground. Therefore, it is dangerous when a front wheel moves upward, and the larger the slope of hill is, the greater danger will a cyclist encounter. In addition, a squatting posture is caused when a seat post of a bicycle is excessively low, and a force is hard to be transferred from legs, leads to slow speed cycling. Furthermore, it is easy to hurt muscles and joints and cause tiredness. Therefore, to avoid danger as abovementioned, a cyclist prefers to pre-lift a height of a seat post of a bicycle for different situations.

For a conventional bicycle seat post, for example, a ‘bicycle seat post’ described in Taiwan Patent No. M552458, disclosing a hexagonal seat bow fixing portion is disposed on one end of the bicycle seat post. The seat bow fixing portion includes: an accommodation portion, an adjusting member, a first clamping and fastening member, a second clamping and fastening member, and a locking and fastening member. A hexagonal accommodation hole is provided on the accommodation portion for engagement with the adjusting member having a relative appearance. The adjusting member is provided with a position changing hole at a position other than a center of the adjusting member. The first clamping and fastening member is disposed on one side of the position changing hole to fix a seat bow of a seat post, and the second clamping and fastening member is respectively located on a left side and a right side of the seat bow fixing portion. The second clamping and fastening member is disposed on another side of the position changing hole of the adjusting member to fix another seat bow of the seat post. The second clamping and fastening member has a second positioning hole. The locking and fastening member is a bolt and a nut. The bolt passes through a first positioning hole of the first clamping and fastening member, the position changing hole of the adjusting member, and the second positioning hole of the second clamping and fastening member, and is then screwed with the nut.

Therefore, when the adjusting member is rotated by a multiple of 60° to be engaged with the accommodation hole, a location of the position changing hole is changed as the angle of the adjusting member is changed, and the first clamping and fastening member and the second clamping and fastening member respectively located on the left side and the right side of the position changing hole are driven to change locations relative to each other, thereby adjusting the location of the seat post of the bicycle.

However, according to the aforesaid prior art, each time the height of the seat post of the bicycle needs to be adjusted, a cyclist needs to stop cycling and then uses a hexagonal wrench to release the nut and pull out the bolt. The adjusting member can change the angle and then be sleeved by the accommodation hole of the accommodation portion only after the bolt is pulled out from the second clamping and fastening member and the adjusting member. The detached parts are likely to fall off, and the detachment and mounting operations require the use of the hexagonal wrench which is inconvenient to carry. This causes great inconvenience and is waste of time and energy.

### SUMMARY

In view of this, a main objective of the present disclosure is to provide a cable-controlled adjusting apparatus of a bicycle handlebar end. A cyclist can rotate an adjusting element which is disposed at a handlebar end, so that a cable is pulled to drive a controller to lift or lower a seat post of a bicycle. In this way, a conventional problem that cycling needs to be stopped and a tooled for adjusting a height of a bicycle seat post is resolved, thereby ensuring cycling safety and a correct posture, avoiding sports injury and improving the efficiency of pedaling.

To achieve the foregoing objective, the present disclosure discloses a cable-controlled adjusting apparatus of a bicycle handlebar end, comprising: a fastening element disposed in the handlebar end and an adjusting element, where the adjusting element comprises a hollow joining portion rotatably joined with the fastening element, and an abutting portion connected to the joining portion away from the fastening element, where a stopping wall is disposed on the abutting portion away from the joining portion, where a plurality of first grooves is disposed in a ring shape on the stopping wall, and two ends of the first groove are respectively a first deep end and a first shallow end, where the first deep end is gradually inclined and in descending depth toward the first shallow end; a fixing element, comprising: a rod body passing through the abutting portion, a stopping member, and an elastic element, where a structure of the stopping member joins with the fastening element, and a head portion is located on one end of the rod body, where a plurality of second grooves is disposed in a ring shape on the head portion toward the stopping wall, and two ends of the second groove are respectively a second deep end and a second shallow end, where the second deep end is gradually inclined and in descending depth toward the second shallow end, the stopping member and the elastic element are located in the joining portion, where one end of the elastic element is fixed to the stopping member and the other end is fixed to the abutting portion, a ball is sandwiched between the first and second grooves, and one end of a cable is connected to the head portion and the other end of the cable passes through the fastening element and is connected to a controller.

The adjusting element further comprises an adjusting portion, the adjusting portion is connected to the abutting portion, the abutting portion is disposed between the joining portion and the adjusting portion, and an outer diameter of the adjusting portion is greater than an outer diameter of the joining portion (211) and an outer diameter of the handlebar end.

A slip-proof pattern or a slip-proof shape is provided on an outer periphery of the adjusting portion.

A protruding portion and a fixing structure extend above and from the head portion, a positioning groove is provided on the protruding portion, the cable passes through the positioning groove, and the cable is fixed to the protruding portion by using the fixing structure.

The fixing structure comprises a screw hole and a screw member disposed on the protruding portion, and the screw member is screwed with the screw hole after one end of the cable extends out of the positioning groove, so that the screw member presses against the end of the cable to fix the end to the protruding portion.

A limiting groove is provided around an outer wall of the rod body of the fixing element, the limiting groove is engaged with a limiting member, and the stopping member is stopped by the limiting member.

The fastening element comprises: a first fastening member joined with the joining portion, a hollow second fastening member, and a plurality of friction members, where the first fastening member tapers off from the handlebar end to form a first tapered surface, a plurality of guiding portions is disposed around an outer peripheral wall of the first tapered surface, and an inner thread portion is provided on an inner peripheral wall of the first tapered surface; the second fastening member comprises an outer thread portion, and a second tapered surface provided on an end of the outer thread portion and tapering off toward the handlebar end, where an inner structure of the second fastening member is engaged with the rod body, and the outer thread portion is screwed with the inner thread portion of the first fastening member; the friction members are disposed around an outer periphery of the second fastening member, where a notch is provided on the friction member and accommodating the guiding portion, a first surface engaged with the first tapered surface is provided on the friction member away from the first fastening member, and the friction members are disposed around the outer peripheral wall of the second fastening member by using an reset member.

A through hole is provided at a center of the second fastening member for the cable to pass through, and a part of the through hole located on the outer thread portion is a polygonal hole engaged with the structure of the rod body.

A flange having a diameter greater than a diameter of the handlebar end is disposed on the first fastening member away from the second fastening member, and the flange abuts against an end surface of the handlebar end.

A restricting groove is provided on an outer wall of each of the friction members, and the reset member is engaged with the restricting groove.

Based on the above, a cyclist may rotate the adjusting element when riding downhill, so that the first and second grooves sandwich the ball, and the ball pushes against the head portion of the fixing element to cause the head portion to leave the stopping wall and pulls the cable, so that the other end of the cable drives the seat post adjusting controller of the bicycle to lower the seat post. In this way, a height of the cyclist is reduced, and diving forward is less dangerous. When riding on a flat road or uphill, the cyclist may rotate the adjusting element, to pull the other end of the cable to drive the seat post adjusting controller of the bicycle, so that the seat post is adjusted to a suitable height. In this way, a conventional problem that cycling needs to be stopped and a tool is required for adjusting a bicycle seat post is resolved, thereby ensuring cycling safety and a correct posture, to avoid sports injury and have a less laborious and more efficient pedaling.

### BRIEF DESCRIPTION OF THE DRAWINGS

FIG. 1 is a motion diagram showing a bicycle ridden downhill;

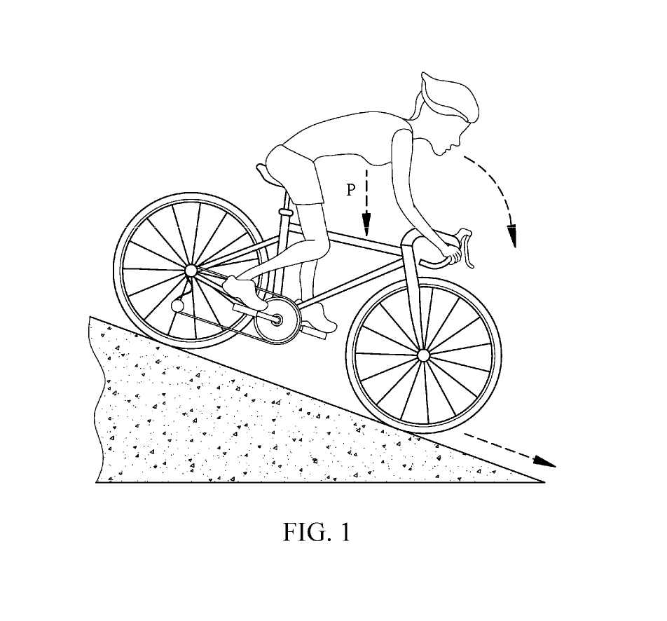

FIG. 2 is a motion diagram showing a bicycle ridden uphill;

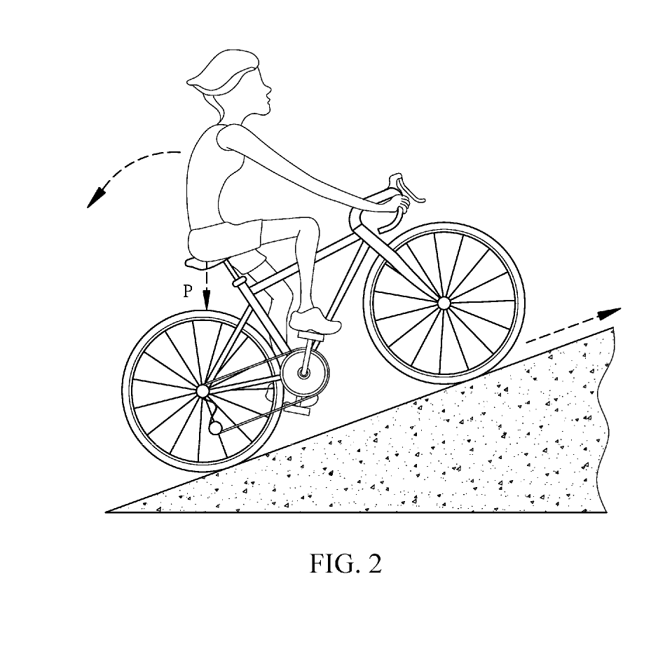

FIG. 3 is a schematic three-dimensional diagram of a bicycle handlebar end according to an embodiment of the present disclosure;

FIG. 4 is a three-dimensional assembled view according to an embodiment of the present disclosure;

FIG. 5 is a three-dimensional exploded view according to an embodiment of the present disclosure;

FIG. 6 is a three-dimensional exploded view in another direction according to an embodiment of the present disclosure;

FIG. 7A is a schematic sectional view of a bicycle handlebar end according to an embodiment of the present disclosure;

FIG. 7B is a sectional view along A-A of FIG. 7A;

FIG. 8A is an assembled sectional view according to an embodiment of the present disclosure; and

FIG. 8B is a motion diagram of FIG. 8A.

### DETAILED DESCRIPTION

Embodiments are used to describe detailed content and technical illustration of the present disclosure. It should be understood that, the embodiments are merely examples for description, and should not be construed as a limitation on implementation of the present disclosure.

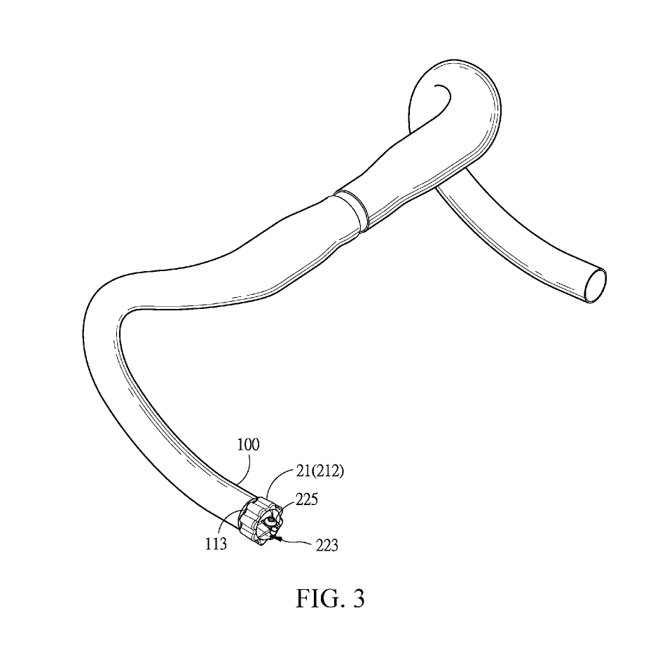

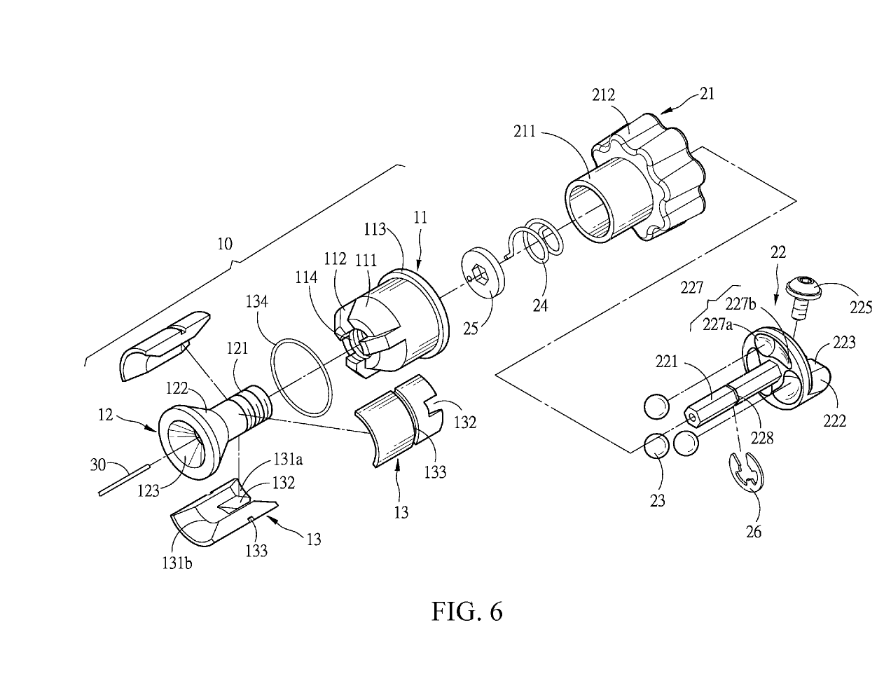

Referring to FIG. 3 to FIG. 7A, the present disclosure discloses a cable-controlled adjusting apparatus of a bicycle handlebar end, including: a fastening element 10 sleeved by a hollow handlebar end 100, an adjusting element 21 mounted on the fastening element 10, a fixing element 22 passing through the adjusting element 21, and a cable 30 passing through the fastening element 10 and the fixing element 22. One end of the cable 30 is fixed to the fixing element 22.

The fastening element 10 includes: a first fastening member 11 and a second fastening member 12 screwed with each other, and a plurality of friction members 13. The first fastening member 11 has a hollow inside and is engaged with the adjusting element 21 and tapers off toward the second fastening member 12 to form a first tapered surface 111. An inner thread portion 114 is provided inside in the first tapered surface 111 of the first fastening member 11. A diameter of an inner peripheral wall of the first fastening member 11 is greater than a diameter of the inner thread portion 114. A plurality of guiding portions 112 protruding from the first tapered surface 111, which are disposed around an outer periphery of the first tapered surface 111 at equal intervals. In the embodiments, three guiding portions 112 are disclosed. A flange 113 having a diameter greater than an outer diameter of the first fastening member 11, which is disposed on the first fastening member 11 away from the second fastening member 12, and the flange 113 abuts against an end surface 101 of the handlebar end.

An outer thread portion 121 is provided on the second fastening member 12 toward the first fastening member 11, and a second tapered surface 122 tapering off toward the handlebar end and connected to the outer thread portion 121. The outer thread portion 121 is screwed with the inner thread portion 114 of the first fastening member 11. A through hole 123 is provided at a center of the second fastening member 12 as a passage for the cable 30. In the embodiments, a part of the through hole 123 locates on the outer thread portion 121 is a polygonal hole 123a.

Two ends of the friction member 13 respectively have a first surface 131a and a second surface 131b. A structure of the first surface 131a is engaged with the first tapered surface 111 of the first fastening member 11. A structure of the second surface 131b is engaged with the second tapered surface 122 of the second fastening member 12. After the outer thread portion 121 of the second fastening member 12 is screwed with the inner thread portion 114 of the first fastening member 11, each of the friction members 13 is accommodating each of the guiding portions 112 of the first fastening member 11 by using a notch 132, each of the notches 132 has configured to accommodate the corresponding guiding portions 112. The friction members 13 are disposed around an outer periphery of the second fastening member 12 at equal intervals. A restricting groove 133 is provided on an outer surface of each of the friction members 13 for engagement with a ring-shaped reset member 134, so that the friction members 13 are bound on the outer periphery of the second fastening member 12. In the embodiments, a quantity of the friction members 13 is three.

A joining portion 211 is disposed on one end of the adjusting element 21 toward the first fastening member 11, and an adjusting portion 212 with a hollow inside is disposed on the other end of the adjusting element 21 away from the first fastening member 11. An abutting portion 213 is disposed between the joining portion 211 and the adjusting portion 212. An outer diameter of the adjusting portion 212 is greater than an outer diameter of the handlebar end 100 and an outer diameter of the joining portion 211. The outer diameter of the joining portion 211 is smaller than the outer diameter of the handlebar end 100 and is sleeved by the inside of the first fastening member 11 and is freely rotatable. A slip-proof pattern or shape is provided on an outer periphery of the adjusting portion 212. A stopping wall 214 is disposed on an end of the abutting portion 213 away from the first fastening member 11. A plurality of first grooves 215 is disposed in a ring shape on the stopping wall 214 at equal intervals. At two ends of the first groove 215, respectively have a first deep end 215a and a first shallow end 215b. The first deep end 215a is gradually inclined and in descending depth toward the first shallow end 215b.

The fixing element 22 is hollow and includes a rod body 221 and a head portion 222. The rod body 221 has a polygonal structure and passes through the abutting portion 213. The rod body 221 engages with the polygonal hole 123a of the second fastening member 12. The head portion 222 is disposed in the adjusting portion 212 and engaged with the stopping wall 214. A protruding portion 223 is disposed on a surface of the head portion 222 away from the handlebar end 100. A positioning groove 224 is provided on the protruding portion 223 and is in communication with the hollow inside of the fixing element 22, and a fixing structure is disposed on the protruding portion 223. The fixing structure includes a screw 225 screwed with a screw hole 226 of the protruding portion. The cable 30 passes through the fixing element 22 and one end of the cable 30 extends out of the positioning groove 224, by screwing the screw 225 with the screw hole 226, the screw 225 presses against the end of the cable 30 to fix the end to the protruding portion 223. The other end of the cable 30 is connected to a controller (which is not drawn herein because this is not a feature of the present disclosure) after the cable 30 passes through the second fastening member 12. The controller can be any kind of cable-controlled bicycle component, for example, may be a front or rear suspension system, front or rear derailleur, a seat post adjusting apparatus, or like. The seat post adjusting apparatus is used as an example of the cable-controlled apparatus connected by the cable in the present disclosure. However, the present disclosure is not limited thereto.

A plurality of second grooves 227 is disposed on the head portion 222 toward the adjusting element 21 at equal intervals. At two ends of the second groove 227, are respectively have a second deep end 227a and a second shallow end 227b. The second deep end 227a is gradually inclined and in descending depth toward the second shallow end 227b. A shape of the first groove 215 is engaged with a shape of the second groove 227, and a ball 23 is sandwiched between the first groove 215 and the second groove 227. A limiting groove 228 is provided around an outer wall of the rod body 221 of the fixing element 22. The rod body 221 passes through the abutting portion 213 of the adjusting element 21, and is then sleeved by an elastic element 24 (for example, a spring that can be stretched axially) and a stopping member 25. One end of the elastic element 24 is fixed to the stopping member 25, and the other end of the elastic element 24 is fixed to the abutting portion 213. The elastic element 24 and the stopping member 25 are accommodated in the joining portion 211. A limiting member 26 such as a C-shaped ring is engaged with the limiting groove 228 to resist a displacement of the stopping member 25.

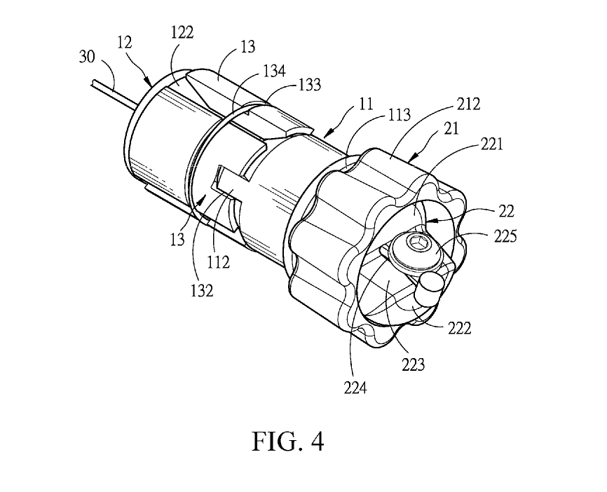

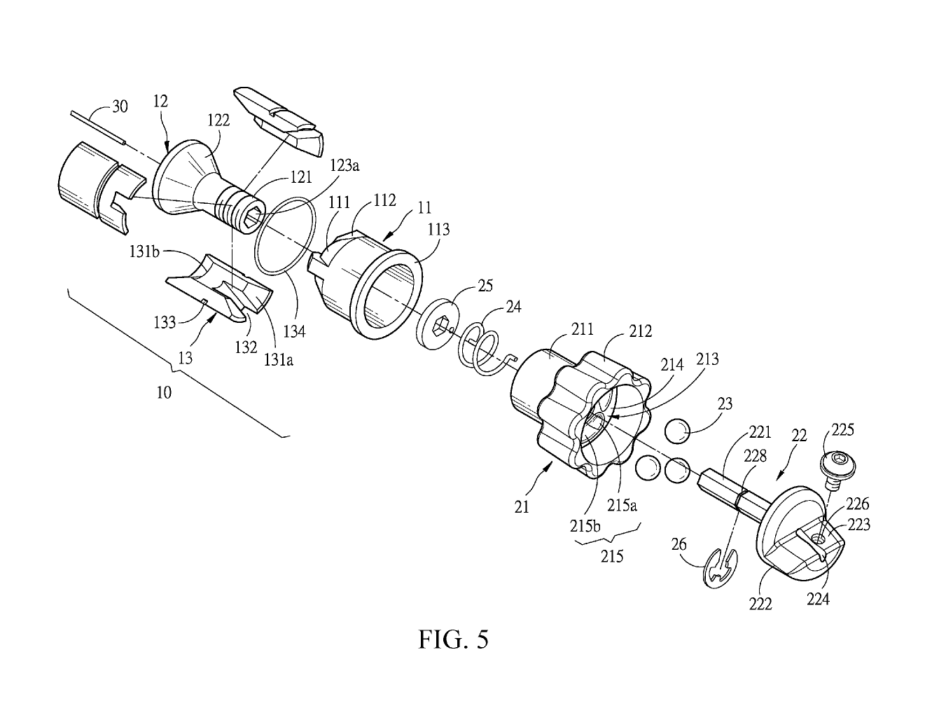

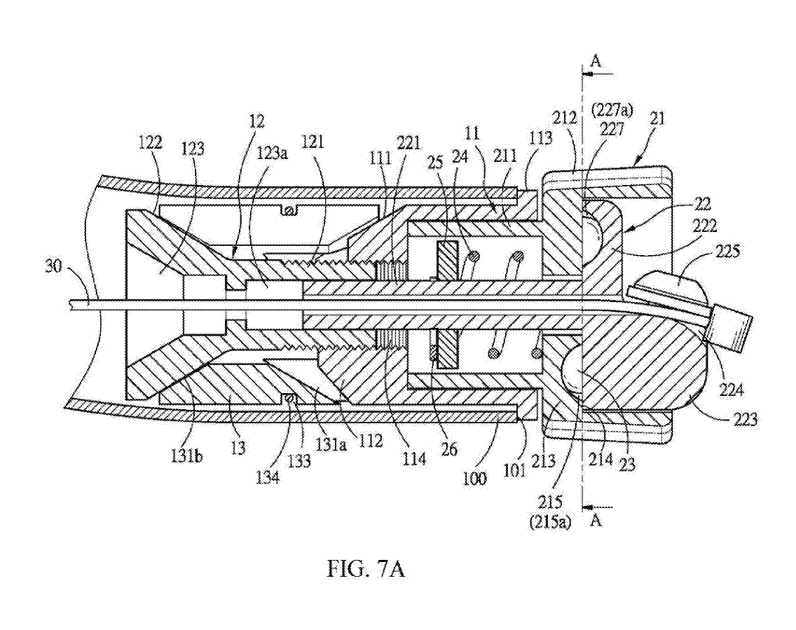

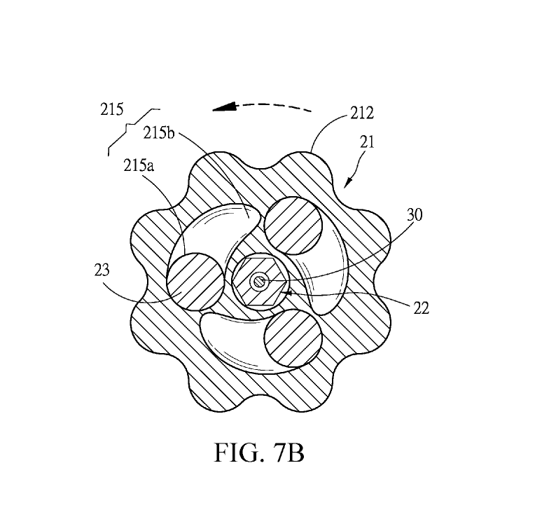

With reference to the foregoing structure, further, referring to FIG. 4, FIG. 5 and FIG. 7A. During assembling, the outer thread portion 121 of the second fastening member 12 is screwed with the inner thread portion 114 of the first fastening member 11. The friction members 13 are disposed around the outer periphery of the second fastening member 12 at equal intervals, and the notch 132 of each friction member 13 is configured to accommodate each corresponding guiding portion 112 of the first fastening member 11 with substantially matched configuration. By engaging the reset member 134 with the restricting groove 133 of each friction member 13, the first surface 131a of the friction member 131 is closely bound to an outer wall surface of the first tapered surface 111 and an outer wall surface of the second tapered surface 122.

During mounting of the present disclosure, the joining portion 211 of the adjusting element 21 abuts against an inner wall of the first fastening member 11. The adjusting element 21 can be driven to rotate. The ball 23 is disposed between the first groove 215 of the adjusting element 21 and the second groove 227 of the fixing element 22. The rod body 221 of the fixing element 22 passes through the abutting portion 213, the elastic element 24, and the stopping member 25, and then engages with the polygonal hole 123a of the second fastening member 12. The limiting member 26 is sleeved to the limiting groove 228 of the fixing element 22, and one end of the elastic element 24 is fixed to the stopping member 25, and the other end of the elastic element 24 is fixed to the abutting portion 213 of the adjusting element 21. The cable 30 passes through the fastening element 10 and the rod body 221 of the fixing element 22 through the inside of the handlebar with one end extending out of the positioning groove 224. Then the screw 225 presses against the end of the cable 30 by screwing the screw 225 with the screw hole 226 of the protruding portion 223. In the embodiments, the other end of the cable 30 is connected to a controller, for example, a hydraulic controller to drive a bicycle seat post to lift or drop so as to adjust a height of the bicycle seat post.

When assembling the fastening element 10 to the handlebar end 100, the fixing element 22 is rotated to drive the second fastening member 12 to rotate. When the second fastening member 12 moves toward the first fastening member 11, the second tapered surface 122 of the second fastening member 12 pushes against the friction members 13, so that the notches 132 of the friction members 13 are also pushed outwardly against the guiding portions 112 of the first fastening member 11 and the first tapered surface 111, thereby tightly abutting against an inner wall of the handlebar end 100 and causing the fastening element 10 to be fixed in the bicycle handlebar.

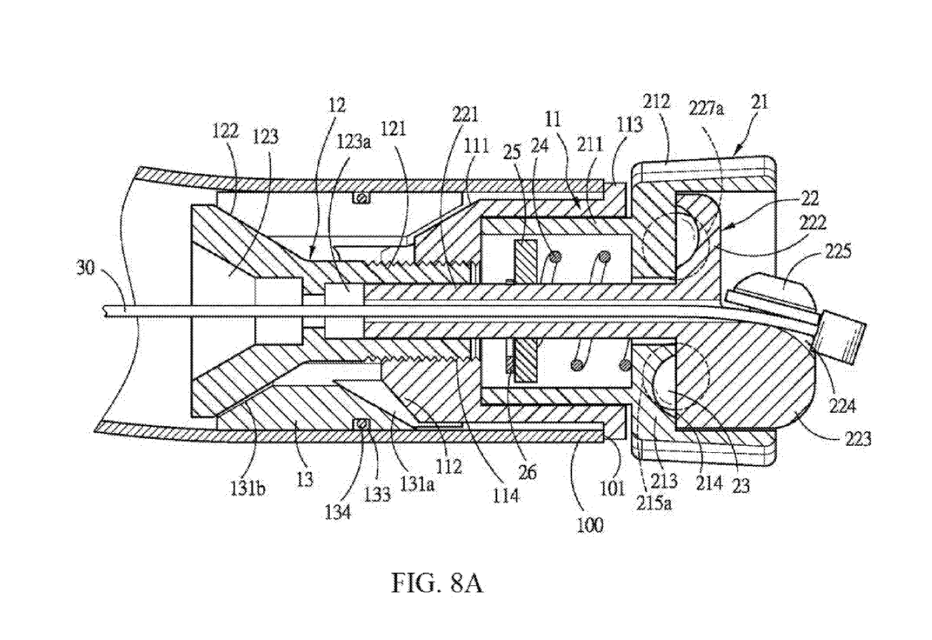

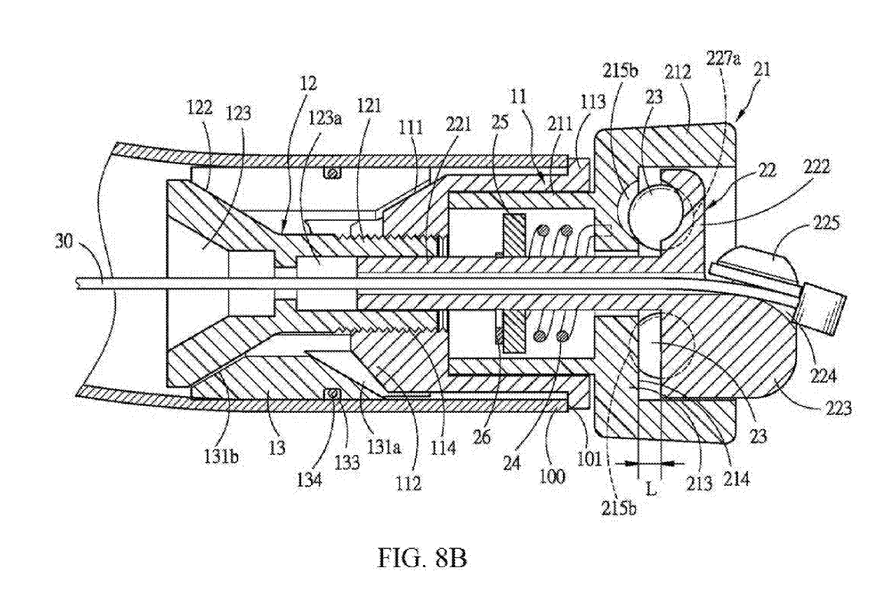

Further, referring to FIG. 7B, FIG. 8A, and FIG. 8B, in a static state, when the ball 23 is sandwiched between the first deep end 215a of the first groove 215 and the second deep end 227a of the second groove 227. Due to the elasticity of the elastic element 25, the head portion 222 abuts against the stopping wall 214 of the adjusting element 21, and the cable 30 does not apply any force on the cable-controlled apparatus of a bicycle.

In a motion state, when a cyclist rotates the adjusting element 21, a location of the ball 23 in the first groove 215 is changed relatively. When the ball 23 is sandwiched and moved from the first deep end 215a of the first groove 215 and the second deep end 227a of the second groove 227 to the first shallow end 215b of the first groove 215 and the second shallow end 227b of the second groove 227, a depth difference between the first deep end 215a and the first shallow end 215b of the first groove 215 and a depth difference between the second end 227a and the second shallow end 227b of the second groove 227 make the ball 23 pushes against the head portion 222 and causes the head portion 222 to be displaced, and formed an axial distance L between the head portion 222 and the stopping wall 214. In addition, the elastic element 24 is in a compressed state when the elastic element 24 is being pressed against by the stopping member 25, thereby pulling the cable 30 and then further triggering the cable-controlled apparatus of a bicycle. When the adjusting element 21 is released from the cyclist, the ball 30 returns to an initial position in its static state by the elasticity of the elastic element 24.

The seat post adjusting controller is used as an example of the cable-controlled apparatus in the embodiments. According to the present disclosure, a cyclist rotates the adjusting element 21 while riding downhill. The ball 23 is sandwiched between the first shallow end 215b of the first groove 215 and the second shallow end 227b of the second groove 227. Thereby, the ball 23 pushing against the head portion 222 of the fixing element 22 so that the head portion 222 is pushed to leave the stopping wall 214 of the adjusting element 21. At the same time, the cable 30, which is connected to the seat post adjusting controller, is being pulled to lower the seat post because of the head portion 222 moves an axial distance L from the stopping wall 214. In this way, a height of the cyclist is reduced, and diving forward is less dangerous. When riding on a flat road or uphill, the cyclist can also rotate the adjusting element 21, to pull the cable 30 to drive the seat post adjusting controller, to adjust a suitable height for a seat post. It is easy for the cyclist to rotate the adjusting element 21 of the handlebar end to pull the cable 30, thereby driving the seat post adjusting controller. In this way, a conventional problem that cycling needs to stop and uses a tool to adjust a bicycle seat post is resolved. As a consequent, the present disclosure can ensure cycling safety and a correct posture of a seat post, also can avoid sports injury and have a less laborious and more efficient pedaling.

The present disclosure at least has the following advantages:

By means of the present disclosure, a cyclist may rotate the adjusting element 21 anytime when riding on roads with different inclinations, so that the cable is pulled by the fixing element 22 to drive the controller to lift or lower the bicycle seat post, thereby adjusting the height of the seat post. In addition, the cable-controlled adjusting apparatus of a bicycle handlebar end has such advantages as simple and light in structure and easy in operation.

Furthermore, in the present disclosure, the hollow fixing element is in communication with the inside of the handlebar, so that the cable can straightly pass though the bicycle handlebar and then pulling the seat post adjusting controller, thereby avoiding winding and turning of the cable, and a problem that the cable might be pulled apart under a force is avoided.

The foregoing objects described by using “the” are merely preferred embodiments of the present disclosure, and are not intended to limit the implementation scope of the present disclosure. Any simple equivalent alteration and modification made according to the claims and the specification of the present disclosure shall fall within the scope of the present disclosure.

What is claimed is:

1. A cable-controlled adjusting apparatus of a bicycle handlebar end, comprising: a fastening element disposed in the handlebar end;
an adjusting element, comprising: a hollow joining portion rotatably joined with the fastening element, and an abutting portion disposed on the joining portion away from the fastening element, a stopping wall is disposed on the abutting portion away from the joining portion, a plurality of first grooves is disposed in a ring shape on the stopping wall, and two ends of the first groove are respectively a first deep end and a first shallow end, wherein the first deep end is gradually inclined and in descending depth toward the first shallow end;
a fixing element, comprising: a rod body passing through the abutting portion and having a structure joined with the fastening element, and a head portion located on one end of the rod body, wherein a plurality of second grooves is disposed in a ring shape on the head portion toward the stopping wall, and two ends of the second groove are respectively a second deep end and a second shallow end, the second deep end is gradually inclined and in descending depth toward the second shallow end, a ball is sandwiched between the first groove and the second groove, and the rod body is sleeved by a stopping member and an elastic element in the joining portion, wherein one end of the elastic element is fixed to the stopping member and the other end is fixed to the abutting portion; and
a cable, one end of the cable is connected to the head portion and the other end passes through the fastening element and is connected to a controller.

2. The cable-controlled adjusting apparatus of a bicycle handlebar end according to claim 1, wherein the adjusting element further comprises an adjusting portion, the adjusting portion is connected to the abutting portion, the abutting portion is disposed between the joining portion and the adjusting portion, and an outer diameter of the adjusting portion is greater than an outer diameter of the joining portion and an outer diameter of the handlebar end.

3. The cable-controlled adjusting apparatus of a bicycle handlebar end according to claim 2, wherein a slip-proof pattern or a slip-proof shape is provided on an outer periphery of the adjusting portion.

4. The cable-controlled adjusting apparatus of a bicycle handlebar end according to claim 1, wherein a protruding portion and a fixing structure extend from the head portion, a positioning groove is provided on the protruding portion, the cable passes through the positioning groove, and the cable is fixed to the protruding portion by using the fixing structure.

5. The cable-controlled adjusting apparatus of a bicycle handlebar end according to claim 4, wherein a protruding portion is provided on a surface of the head portion away from the handlebar end, the fixing structure comprises a screw hole and a screw member disposed on the protruding portion, and the screw member is screwed with the screw hole after one end of the cable extends out of the positioning groove, the screw member presses against the end of the cable to fix the cable to the protruding portion.

6. The cable-controlled adjusting apparatus of a bicycle handlebar end according to claim 1, wherein a limiting groove is provided around an outer wall of the rod body of the fixing element, the limiting groove is engaged with a limiting member, and the stopping member is restricted by the limiting member.

7. The cable-controlled adjusting apparatus of a bicycle handlebar end according to claim 1, wherein the fastening element comprises: a first fastening member joined with the joining portion, the first fastening member tapers off from the handlebar end to form a first tapered surface, a plurality of guiding portions is disposed around an outer peripheral wall of the first tapered surface, and an inner thread portion is provided on an inner peripheral wall of the first tapered surface;
a hollow second fastening member, comprising: an outer thread portion, and a second tapered surface provided on an end of the outer thread portion and tapering off toward the handlebar end, an inner structure of the second fastening member is engaged with the rod body, and the outer thread portion is screwed with the inner thread portion of the first fastening member; and
a plurality of friction members, disposed around an outer periphery of the second fastening member, a notch is provided on the friction member and accommodating the guiding portion, a first surface engaged with the first tapered surface is provided on the friction member toward the first fastening member, and the friction members are disposed around the outer peripheral wall of the second fastening member by using an reset member.

8. The cable-controlled adjusting apparatus of a bicycle handlebar end according to claim 7, wherein a through hole is provided at a center of the second fastening member for the cable to pass through, and a part of the through hole located on the outer thread portion is a polygonal hole engaged with the structure of the rod body.

9. The cable-controlled adjusting apparatus of a bicycle handlebar end according to claim 7, wherein a flange having a diameter greater than a diameter of the handlebar end is disposed on the first fastening member away from the second fastening member, and the flange abuts against an end surface of the handlebar end.

10. The cable-controlled adjusting apparatus of a bicycle handlebar end according to claim 7, wherein a restricting groove is provided on an outer wall of each of the friction members, and the reset member is engaged with the restricting groove.
